(19) United States
(12) Patent Application Publication
(10) Pub. No.: US 2011/0003275 A1
(43) Pub. Date: Jan. 6, 2011

(54) SYSTEM AND METHOD FOR ORGAN EVALUATION AND PRESERVATION

(75) Inventors: Stig Steen, Lund (SE); Audrius Paskevicius, Lund (SE)

Correspondence Address: BROOKS KUSHMAN P.C., 1000 TOWN CENTER, TWENTY-SECOND FLOOR, SOUTHFIELD, MI, 48075, US

(73) Assignee: IGELOSA TRANSPLANTATION SCIENCE AB, Lund (SE)

(21) Appl. No.: 12/667,187

(22) PCT Filed: Jul. 7, 2008
(86) PCT No.: PCT/SE2008/000435

§ 371 Date: Dec. 29, 2009

Related U.S. Application Data
(60) Provisional application No. 60/929,651, filed on Jul. 6, 2007.

(30) Foreign Application Priority Data
Jul. 6, 2007 (SE) 0701634-8

(51) Int. Cl. A01N 1/02

(52) U.S. Cl. 435/1.2; 435/284.1

(57) ABSTRACT

A method and system for organ evaluation and preservation for connection to an organ and for recirculation of a perfusion medium there through. The system comprises a first collection device for collection of the perfusion medium perfused through the organ and a second collection device arranged in an outlet conduit from the first collection device. A pump passes the perfusion medium from the second collection device to the organ via a conduit. A flow regulation device, such as an on-off clamp, is arranged in the outlet conduit for controlling the flow in the outlet conduit in order to maintain a constant fill of the second collection device as measured by a fluid level sensing device.

### TECHNICAL FIELD OF INVENTION

The present invention relates to a system and a method for organ evaluation and preservation.

### BACKGROUND OF INVENTION

Human and animal organs intended for transplantation may be evaluated as to condition and compatibility with the organ receiver before deciding whether the organ is suitable for transplantation. For this purpose, several parameters of the organ are measured and evaluated. In order to maintain the structure and function of the organ as much as possible before transplantation, the organ is continuously perfused with a solution having maintenance ability at least during the evaluation.

According to known methods for evaluation and preservation of organs to be transplanted, the organ is connected to a system, in which a perfusion medium is arranged to pass through said organ. The perfusion medium may be oxygenated and recirculated to the organ by use of a pump. Such a continuously operated system is capable of maintaining the structure and function of the organ for several hours.

One example of such a method and system is disclosed by Stig Steen et al in Lancet 2001: 825-829. One problem encountered in such a system is the formation of airlocks and air bubbles in the perfusion medium recirculated in the system, which may destroy or damage the organ if they are not eliminated. This system comprises two reservoirs through which the perfusion medium is circulated in sequence. Since the emptying ratios of these reservoirs are not ideal, each one runs a risk to be completely emptied. Then airlocks or air bubbles can enter into the system. Use of the system has so far required manual monitoring and intervention to handle this problem.

After evaluation and determination that the organ is suitable for transplantation or other use, the organ should be stored under conditions, which are not detrimental for the organ. This normally involves cooling of the organ to a low temperature, at which the organ may be perfused only to a small degree. Instead or additionally, the preservation medium surrounds the organ at the outside thereof. The perfusion medium may be oxygenated and this medium may be recirculated. In this case, additional preservation medium may be added so that the organ is more or less immersed in the preservation medium. Then, it is required to ensure that the level of preservation medium is maintained at a suitable level.

Thus, there is a need for a safe and continuous system for evaluation and preservation of organs before transplantation.

### SUMMARY OF THE INVENTION

Accordingly, an object of the present invention is to mitigate, alleviate or eliminate one or more of the above-identified deficiencies and disadvantages singly or in any combination.

According to an aspect of the invention, there is provided a system for organ evaluation and preservation for connection to an organ and for recirculation of a perfusion medium, comprising: a first collection device for collection of the perfusion medium perfused through an organ; a fluid level sensing device; a flow regulation device; a first conduit passing the perfusion medium to the organ, and a second conduit connected between the first perfusion medium collection device and a second perfusion medium collection device; wherein the level of the perfusion medium in the second perfusion medium collection device is controlled by the fluid level sensing device and the flow regulation device, which is connected with the fluid level sensing device and is arranged in the second conduit, and wherein said first conduit is connected between said second perfusion medium collection device and said organ.

According to an embodiment, the fluid level sensing device may sense a fluid level based on IR, induction, capacitance, UV, or radio waves, or a combination thereof, preferably IR. The flow regulation device may be an on-off clamp, a partial clamp, or a roller pump.

According to another embodiment, the system may further comprise a control unit connected to the fluid level sensing device for controlling the flow regulation device. The system may further comprise a pump, such as a roller pump or a centrifugal pump, arranged in the first conduit between the second perfusion medium collection device and the organ. The system may further comprise an oxygenation device, optionally comprising a heat exchanger. The system may further comprise an air bubble detector and/or a defoaming device.

According to a further embodiment, the organ to be connected to the system may be of human or animal origin and is a lung, a heart, a liver, a kidney, a pancreas, an intestine, or an extremity, or a part thereof. The perfusion medium to be passed through the organ and to be recirculated in the system may be blood, heparinized natural blood, or Steen solution.

According to yet another embodiment, the system may further comprise a shunt conduit arranged to bypass the first collection device during a preconditioning step, whereby the perfusion medium is arranged to pass in a closed circuit for adjusting the perfusion medium, for example to a desired temperature and/or amount of dissolved gases.

In another aspect, there is provided a system for organ evaluation and preservation for connection to an organ and for recirculation of a perfusion medium, comprising: a first collection device for collection of the perfusion medium perfused through an organ; a fluid level sensing device; a flow regulation device; a first conduit passing the perfusion medium to the organ, and a second conduit connected between the first perfusion medium collection device and a human or animal patient, wherein the level of the perfusion medium in the first perfusion medium collection device is measured by the fluid level sensing device and controlled by the flow regulation device, which is arranged in the conduit, wherein said conduit is arranged between the human or animal patient and the organ.

In a further aspect, there is provided a system for organ evaluation and preservation for connection to an organ and for recirculation of a perfusion medium, comprising: a first collection device for collection of the perfusion medium which is passed onto or surrounds an organ; a fluid level sensing device; a flow regulation device; a first conduit passing the perfusion medium onto or surrounding the organ, and a second conduit connected between the first perfusion medium collection device and a second perfusion medium collection device; wherein the level of the perfusion medium in the second perfusion medium collection device is controlled by the fluid level sensing device and the flow regulation device, which is connected with the fluid level sensing device and is arranged in the second conduit, and wherein said first conduit is connected to said second perfusion medium collection device passing the perfusion medium onto or surrounding the organ.

In yet another aspect, there is provided a method for organ evaluation and preservation, wherein an organ to be transplanted is connected ex-vivo to a system as described above, and is repeatedly perfused with the perfusion solution and evaluated until it has been determined whether the organ is suitable for transplantation, or until the transplantation is to be performed.

In a still further aspect, there is provided a method for organ evaluation and preservation, wherein an organ to be transplanted to a predetermined organ receiving human or animal patient and said human or animal patient both are connected to the system as mentioned above and is repeatedly perfused with a perfusion medium, such as blood, circulating in the system and is evaluated until it has been decided whether said organ is suitable for transplantation to said predetermined human or animal patient, or until the transplantation is to be performed.

### BRIEF DESCRIPTION OF THE DRAWINGS

Further objects, features and advantages of the invention will become apparent from the following detailed description of embodiments of the invention with reference to the drawings, in which:

FIG. 1 is a schematic view showing an embodiment of the system according to the invention, wherein an organ to be transplanted is preserved and evaluated.

FIG. 2 is a schematic view similar to FIG. 1 and showing another embodiment of the system.

FIG. 3 is a schematic view similar to FIG. 1 and showing a further embodiment of the system during preservation of the organ.

### DETAILED DESCRIPTION OF EMBODIMENTS

Below, several embodiments of the invention will be described with references to the drawings. These embodiments are described in illustrating purpose in order to enable a skilled person to carry out the invention and to disclose the best mode. However, such embodiments do not limit the invention. Moreover, other combinations of the different features are possible within the scope of the invention.

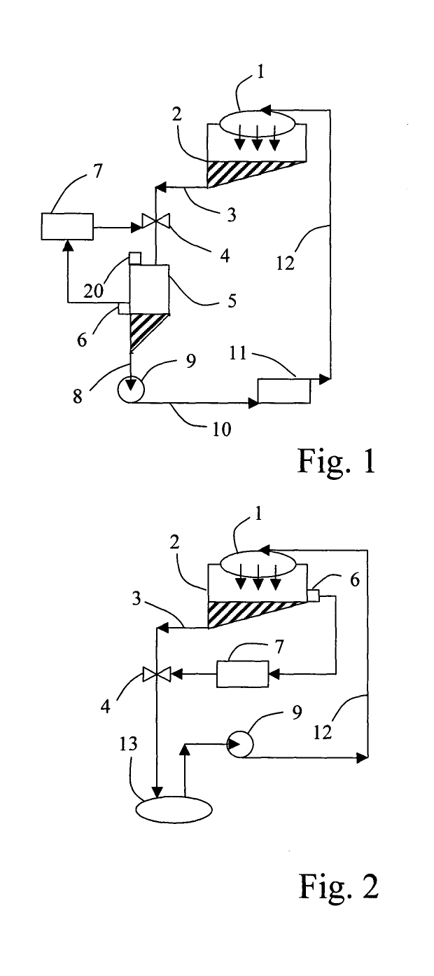

In an embodiment of the invention, which is shown in FIG. 1, the system is used with an organ 1 to be evaluated and perfused with a perfusion medium. Said organ 1 may be a lung, a heart, a liver, a kidney, a pancreas, an intestine, or an extremity, or a part thereof, from a human being or an animal, and may be subject to any kind of transplantation or other use.

The perfusion medium may be e.g. Steen solution, which is a commercially available preservation solution comprising serum albumin and dextran in specified concentrations, see WO 02/35929, the technical contents of which is incorporated in the present specification by reference, e.g. with added erythrocytes to a hematocrite value of 15%. Another preservation solution may be heparinized natural blood or blood substitutes lacking e.g. toxic components present in natural blood, but compensated with other components, depending on the organ to perfuse or preserve.

Said perfusion medium is passed via a conduit 12 to one or several blood vessel of the organ 1, such as one or several arteries, depending on the organ to perfuse.

The organ 1 is conveniently placed above a first collection device 2, which can be any kind of suitably formed container of plastic or metal. The first collection device 2 collects the perfusion medium passing through said organ 1 during the perfusion and out through one or several blood vessels, such as one or several veins of the organ.

The organ 1 may be placed on a surface, e.g. a downwardly sloping or curved plate, such as a Plexiglas® sheet, above the first collection device 2, whereby blood passing through the organ 1 and out through the blood vessels may flow down to the first collection device 2 via the side edges of the sheet or plate or via one or several openings in the surface, e.g. close to one or several of the vertical side walls of the first collection device 2.

In another embodiment the organ 1 may be placed or suspended inside said first collection device 2.

Said first collection device 2 may be any kind of conventional blood collection device. In one embodiment, shown in FIG. 1, said first collection device 2 has an inclined bottom surface for facilitating the outflow of perfusion medium perfused through said organ 1 and collected at the bottom of said first collection device 2.

The first collection device 2 is normally open to the atmosphere, since it may be required to observe or touch the organ during the evaluation and preservation.

During use, the perfusion medium collected in the first collection device 2 is passed through a conduit 3 to a second collection device 5. In the embodiment shown in FIG. 1, the perfusion medium is passed from the first collection device 2 to the second collection device 5 by use of gravity only. However, said perfusion medium may also be passed from the first collection device 2 to the second collection device 5 by a pump located in the circuit 3, e.g. a roller pump or any occlusive pump, e.g. as an alternative or addition to the use of gravity.

The perfusion medium passed to the second collection device 5 is collected in the bottom thereof, which also may be provided with an inclined bottom surface.

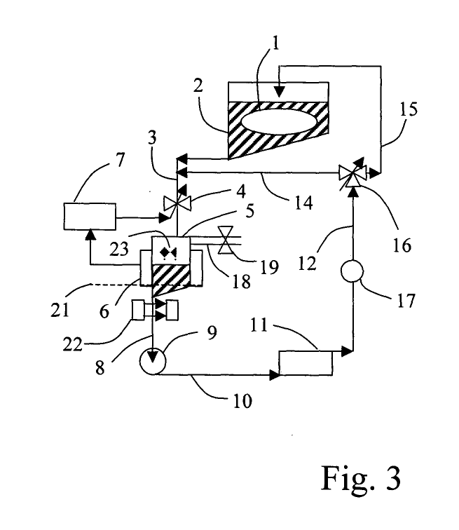

An air space is present in the top of the second collection device 5 above the surface of the perfusion medium collected. The air volume in the air space may be adjusted via an opening 18 in the upper portion of the second connection device 5, as shown in FIG. 3. The flow of air through the opening 18 may be controlled by a valve 19.

The second collection device 5 may be a conventional device, e.g. a Trillium Affinity NT CV/R Cardiothomy/Venous Reservoir with Trillium Biopassive Surface from Methronix. Such a device is also called a “hard shell reservoir”, because the volume of the reservoir is substantially independent of the pressure inside the reservoir.

The second collection device 5 may be provided with an inlet for perfusion medium from the conduit 3 and an outlet for perfusion medium to be returned to the organ 1. Said second collection device 5 may also be provided with an opening 20 for sampling and an opening for the connection of a shunt from the oxygenation device 12. The opening 20 may be provided with a septum, through which a needle of a syringe may be passed to sample the preservation medium. The opening 20 may also be used for supplying air via the syringe to the upper portion of the second collection device 5 as described below in connection with FIG. 3. Furthermore, said second collection device 5 may also be provided with a built-in defoamer device for example as described in U.S. Pat. No. 3,545,937.

The perfusion medium is pumped out from the bottom of the second collection device 5 via a conduit 8 with a pump 9 and is passed via a conduit 10 to another device, such as an oxygenation device 11. In FIG. 1 the conduit 8 may be regarded as parts of the conduit 12, which above is defined to be connected between the second collection device 5 and the organ 1. Said pump 9 may be any conventional pump. In an embodiment, the pump is a roller pump or a centrifugal pump. Said oxygenation device 11, which also can be regarded as a gas exchange device (in certain cases 100% nitrogen is used), solves a gas mixture into the perfusion medium to be passed to the organ 1 for maintaining the blood gas composition in the perfusion medium.

In an embodiment, the oxygenator is a continuously operated membrane oxygenator, for example for adult use, and also includes a built-in heat exchanger, which may regulate the temperature of the perfusion medium, for example depending on the perfusion medium flow rate through the organ 1 during operation. A temperature regulation of the perfusion medium is required, since the temperature thereof may be reduced when it passes through the organ 1 in the initial stage of the perfusion cycle when the organ 1 may have a reduced start temperature, for example due to a previous cold storage. The temperature of the perfusion medium should be the normal body temperature, i.e. about 37° C., during evaluation. However, during preservation, the temperature of the perfusion medium may be lower, such as 4° C. to 8° C. A suitable oxygenation device 11 is a Hollow Fiber Oxygenator with Trillium™ Biopassive Surface (Trillium™ 511 T, AFFINITY NT 9525).

Before use of the system according the present invention a priming step is performed, i.e. a shunt may be connected between said oxygenation device 11 and the second collection device 5, or between the conduits 12 and 3, and the perfusion medium is brought to circulate in the circuit obtained until a balance of gases and other parameters of the medium is achieved, i.e. without passage of the organ 1 as is described in more detail below with reference to FIG. 3.

The oxygenated and temperature regulated perfusion medium is then passed through the conduit 12 to the organ 1 for further repeated perfusion and recirculation steps. The organ 1 and the first collection device 2, as well as the parts of the conduits 3 and 12, respectively, close to the first collection device 2 may be kept under substantially sterile or aseptic conditions.

The function of the second collection device 5 is to store the perfusion medium during priming and initial recirculation of the system before the organ 1 is connected. It is also used to eliminate as much air bubbles as possible in the system, which can arise during operation of the system. If such bubbles in the perfusion medium would be recirculated to the organ 1, it may be destroyed or damaged.

The flow through the conduit 12 may also be provided with an air filter 17, eliminating air bubbles.

If a roller pump is used as the pump 9, any bubbles present in the perfusion medium may be fed to the organ 1 with a fatal result. If a centrifugation pump is used as the pump 9, the bubbles may be caught or enclosed therein. However, such bubbles have to be released from the pump, which then has to be stopped, thereby interrupting the perfusion treatment and subjecting the organ 1 to a possibly detrimental rest period. These problems have been partially solved, as stated above, by use of manual unreliable monitoring and intervention requiring continuous attention. Another parameter to consider is that the flow of perfusion medium through the organ varies during operation of the system due to the blood vessel resistance within the organ. Initially, the flow of perfusion medium through the organ may be low, but it increases gradually during operation until a nominal flow is obtained. The flow may be dependent on the temperature of the organ.

Thus, it is important to obtain a flow of perfusion medium without any air bubbles to the organ 1 and automatically adaptable to flow fluctuations obtained in the system. Such a flow is obtained according to the present invention by controlling the perfusion medium level in the second collection container 5, e.g. at a constant or essentially constant level, and regulating the perfusion medium flow from the first collection container 2. More precisely, the level of the perfusion medium is preferably automatically monitored and kept constant or essentially constant by the use of a fluid level sensing device 6 connected to the second collection device 5 and also connected to a flow regulation device 4, arranged in the conduit 3, e.g. via a control unit 7, as shown in FIG. 1.

The expression “constant or essentially constant value” used herein in connection with the level of the perfusion medium in the second collection device 5 is meant to be a predetermined suitable level, for example marked in an observable way in the second preservation medium collection device 5 and having an acceptable variation, which can be determined by a skilled user of the specific control unit 7, in relation to a predetermined level value. The level is monitored by the fluid level sensing device 6 in dependence of the desired level.

The fluid level sensing device 6 may be a conventional device sensing and measuring the fluid level in the second collection container 5 based on ultrasound, IR, UV or visible light, induction, capacitance, radio waves, mechanical means or any combinations thereof. It may be a float or pressure sensing device optionally mechanically interacting with the flow regulation device 4. In an embodiment, the fluid level sensing device 6 may be an IR detector arranged on both sides (see FIG. 3) of the second collection device 5. It is also possible to use a wave length of said IR detector in view of the erythrocyte light absorption in the perfusion medium. The signal provided from the fluid level sensing device 6 may be binary or a continuous value proportional to the level.

The flow regulation device 4 present in the conduit 3 may be a conventional device. In an embodiment, the flow regulation device is an on-off clamp, which is either opened or closed during certain time periods determined by the control unit 7. In another embodiment, it is a continuous clamp, which is gradually opened or closed based on signals from the fluid level sensing device 6. In yet another embodiment it is a roller pump or an occlusive pump, the speed of which is based on signals from the fluid level sensing device 6.

As explained above, the liquid levels in the first collection device 2 and the second collection device 5 may not be too low, which may result in that air may be introduced into the flow. The organ 1 may require different flow rates, up to a maximum flow rate. For a lung, the normal maximum flow rate may be about 4 to 5 liter/min. Then, the flow circuit may be dimensioned for a maximum flow rate of for example 6 liter/min. The second collection device 5 is arranged below the first collection device 2 and the flow takes place by the hydrostatic pressure exerted by the liquid due to the height difference. If the flow regulation device 4 is opened, the arrangement is so, that flow of 6 liter/min may arise when the pressure inside the second collection device 5 is essentially atmospheric pressure. Then, the liquid pillar height between the collection device 2 and the collection device 5 in the conduit 3 corresponds to the flow resistance in the conduit 3.

The pump 9 is adjusted to a desired flow rate, and delivers such flow rate substantially independent on the inlet pressure in the second collection device 5.

If the flow rate of the pump 9 is adjusted to a lower value of for example 2 liter/min, the liquid in the bottom of the first collection device 2 will flow out to the conduit 3 at a higher flow rate of for example 6 liter/min. The result will be that the pressure inside the second collection device 5 increases so that the flow rate decreases. However, there is a risk that the first collection device 2 runs out of liquid, so that air is introduced into the conduit 3. In order to avoid this risk, the flow regulation device 4 is controlled by the control unit 7 so that the level in the second collection device is substantially constant. This means that the flow regulation device 4 controls the flow in conduit 3 to become the same in average as the flow rate of the pump 9, such as 2 liter/min. Thus, the risk of entering air into conduit 3 is being counteracted.

The flow regulation device 4 may be operated in different manners. If the flow regulation device 4 is an electromagnetically operated valve, one way to operate the valve is to close the valve 4 at substantially regular intervals, for example once per second, whereupon the valve is opened when the level in the second collection device 5 falls to the desired level, as indicated by the level sensing device 6.

The flow regulation device 4 may be another device, which generates a controlled restriction, so that the flow may be more or less constant.

The control unit 7 may be operated on the basis of a suitable regulation model. In the case the flow regulation device 4 is an on-off clamp, the control unit 7 calculates, on the basis of the signal obtained from the fluid level sensing device 6, how long the flow regulation device 4 must be open and closed, respectively.

In order to eliminate or reduce ripple, the control unit 7 may provide a certain time delay or a time hysteresis in the signal to the flow regulation device 4, which means that said flow regulation device 4 is not influenced by small fluctuations of the fluid level in the second collection device 5. This hysteresis effect could also be obtained by use of two fluid level sensing devices 6 arranged on the second collection device 5 or by a continuous level sensing device 6 as shown in FIG. 3. The regulation of the flow regulation device 4 may also be based on a P (proportional), a PI (proportional and integral) or a PID (PI and derivative) control model. Thus, when the perfusion medium level in the second collection device 5 reaches a certain level which should be “constant or essentially constant” according to the definition above, the fluid level sensing device 6 indicates via the control unit 7 to the flow regulation unit 4 to adjust the perfusion medium flow through the conduit 3. When the perfusion medium level in the second collection device 5 is reduced under said certain level, the flow regulation device 4 increases the perfusion medium flow in said conduit 3.

In such a way, air bubbles or air locks cannot be created in the system, due to the fact that the emptying ratio of both of the collection devices 2 and 5, respectively, is equal and a sufficient fluid level is maintained in both of these collection devices.

An air bubble detector 22 may be arranged in the conduit 8 below or after the second collection device 5. If there are too many air bubbles in the system, the air bubble detector 22 may initiate an alarm signal, such as lighting a LED, light emitting diode.

The whole system according to the present invention when connected to an organ 1 to perfuse may be regarded as a closed system, and the interior of all of the components thereof are sealed in relation to the surrounding atmosphere. Said organ 1 is kept in an atmosphere, which is sufficiently humid to maintain its integrity and functions. The perfusion of said organ may be performed for several days, e.g. up to seven days, however, often only 8 h, such as 1-2 h. The total volume of perfusion medium circulated in the system may be about 2.5 L, but may be about 1.0-1.5 L depending on the size and type of organ to perfuse. The flow rate of the perfusion medium may be 4-5 L/min for a lung, but may be about 2 L depending on the type and size of the organ to perfuse.

The fluid level sensing device 6, the flow regulation device 4, the conduits 3, 8, 10, and 12, respectively, the pump 9, and the oxygenation device 11, all have inner surfaces compatible with the perfusion medium. The conduits may be made of e.g. PVC or silicone, optionally with specific compatible coatings. The perfusion medium circulated in the system is compatible as to blood group with the organ through which it is to be perfused.

Another aspect of the present invention is based on the situation where an organ to be transplanted to a human or an animal patient is preconditioned or tested as to compatibility with said human or animal with a view to evaluating whether a transplantation is to be made. In one embodiment of this aspect, which is shown in FIG. 2, and which is partly identical with the embodiment shown in FIG. 1, blood is pumped with a pump 9 directly from a blood vessel of the body of the human or animal patient to the organ 1 to perfuse via a conduit 12. The blood may be modified before it reaches the organ 1 by e.g. elimination of fibrinogen and/or inactivation of certain toxic compounds, e.g. complements, and in such a case the perfusion medium reaching and passing through the organ is not blood. Perfusion medium. e.g. that blood, which has passed through the organ 1, is collected in a first collection device 2, e.g. identical with that disclosed in FIG. 1. The perfusion medium is then passed from the first collection device 2 via gravity or a pump back to a blood vessel of the body of the human or animal patient via a conduit 3. With a view to avoiding harmful formation of bubbles and airlocks in the perfusion medium flow through the conduit 3, which would be fatal if they would reach the human or animal patient, the blood flow is regulated by a fluid level sensing device 6 connected to the first collection container 2 and being in contact with a flow regulation device 4, e.g. via a control unit 7. The perfusion medium level in the first collection container 2 is sensed by the fluid level sensing device 7 and indicates to the flow regulation device 4 to either restrict or increase the perfusion medium flow through the conduit 3 according to the same principles as for the embodiment shown in FIG. 1 and disclosed above. The components included in this embodiment may be the same as the corresponding components disclosed in connection with FIG. 1, as well as the optional additional devices.

In addition to the part of the system in FIG. 1, which is kept under sterile conditions, the conduits to and from the human or animal patient, as well as the patient itself, should be kept under sterile or aseptic conditions.

The system disclosed in connection with the embodiment shown in FIG. 2 may also be operated under the same conditions as stated for the embodiment shown in FIG. 1.

FIG. 3 discloses the devices for recirculating the preservation medium before use. A valve 16 is arranged in conduit 12. The valve normally directs the flow in conduit 12 to a conduit 15 connected to the organ. Before use, the system is conditioned by adjusting the valve 16 to connect conduit 12 to a shunt conduit 14, which passes the preservation medium in conduit 12 to the outlet conduit 3 from the first collection device. Before use, the second collection device 5 is completely filled with the preservation medium, i.e. there is no air in the second collection device 5. The pump 9 is operated to circulate the preservation medium through the shunt circuit 14 and the circuit so established. The oxygenator is 11 is operated to condition the preservation medium by dissolving the desired amounts of gases, such as oxygen, carbon dioxide, nitrogen etc. In addition, the preservation medium is conditioned to a desired temperature.

When the desired condition has been obtained, the valve 16 is adjusted to direct the flow in conduit 12 to the conduit 15 and further to the organ. A valve 19 in an inlet 18 to the second collection chamber 5 may be opened to allow air to enter the second collection chamber 5 until the liquid level in the second collection chamber has reached a desired level as indicated by the level sensing device 6. Then, the valve 19 is closed and is kept closed during normal operation.

FIG. 3 also discloses the condition when the organ is preserved. After the organ has been evaluated and found eligible for transplantation, the organ needs to be stored in a condition, which is non-detrimental for the organ. This normally means that the organ is stored in a cooled condition. Thus, the preservation medium that perfuses the organ, as shown in FIG. 1 is cooled. When the organ has reached a specific temperature, the conduit 12 is removed from the organ, and the preservation solution is circulated outside the organ in order to cool the organ from the outside. This may be because the organ cannot be perfused in a cold condition or of other reasons.

In order to surround the organ with preservation medium, additional preservation medium may be added to the first collection device 2 in order to increase the liquid level in the first collection device as shown in FIG. 3. The preservation medium may be the same as used during the evaluation but may be another less expensive medium. The medium is circulated in the circuit and normally through the oxygenator so that the medium is still oxygenated, when oxygenation is desired.

The operation of the flow regulation device 4 may be maintained but normally there is no risk of entering air into the system. Moreover, the addition of air is not detrimental, since the medium is not passed through the organ. Thus, the flow regulation device 4 may be opened all the time.

In another operation, no additional preservation medium is added, but the conduit 12 or the conduit 15 is allowed to drip preservation medium from above at the organ, so that the organ is cooled from the outside. In this operation, the flow regulation device 4 is still operated to maintain a sufficient volume of preservation medium in the first collection device 2.

In a further operation, the fluid level device 6 is arranged to measure the liquid level in the second collection device 5 in a continuous manner. After the evaluation step, during the preservation step, the control circuit 7 and the flow regulation device 4 are arranged to adjust the liquid level in the second collection device to a low level indicated by a broken line 21 in FIG. 3. In this way, the liquid level in the first collection device 2 is increased, which means that no or only a small amount of preservation liquid needs to be added during the preservation step.

### EXAMPLES

The system according to the present invention has been tested for a pig lung to be transplanted.

The system used corresponds to the system shown in FIG. 1 and includes a first collection device of the kind disclosed above, and a Trillium Affinity NT CV/R Cardiothomy/Venous Reservoir with Trillium Biopassive Surface (from Methronix) as the second collection device. The conduits 3, 8, 10, and 12, respectively, are conventional silicone tubings.

An IR based fluid level detector was used as the fluid level sensing device, a conventional control unit was used as the control unit, and a conventional on-off clamp was used as the flow regulation device. The pump used for the system was a conventional centrifugal pump.

The system was primed by circulating a Steen solution with added erythrocytes to a hematocrite value of 15% as the perfusion medium through a Hollow Fiber Oxygenator with Trilliuimm Biopassive Surface (Trilliumm™511 T, AFFINITV® NT 9525) as the oxygenation device via a shunt to the second collection device and then via the pump back to the oxygenation device, etc, with a view to obtaining a balance of blood gas and other parameters of the perfusion medium.

Then a pig lung was placed onto the first preservation medium collection device and was coupled to the conduit 12. The perfusion medium was then circulated through the system by use of only gravity between the first collection device and the second collection device and by use of the pump. The heat exchanger included in the oxygenation device regulates the temperature of the perfusion medium with a gradual increase until the temperature of the perfusion medium passing through the pig lung has reached a level of about 37° C.

The use of the fluid level sensing device, the control unit and the flow regulation device allows for a continuous and even flow through both the collection devices without emptying any of these, thereby eliminating the risk for formation of air bubbles in the circulating perfusion medium. This also makes manual interventions and continuous manual monitoring unnecessary. In such a way a continuous circulation of the perfusion medium through the pig lung was achieved during 3 days. During this time the pig organ could be evaluated and/or stored until transplantation was to be performed.

The system according to the second embodiment of the present invention has also been successfully tested with a pig lung to be transplanted into another pig, wherein blood from the pig was brought to pass through the lung to be transplanted and wherein blood passing the organ was recirculated back to the pig in a regulated way without formation of any air bubbles in the system, thereby allowing evaluation and/or storage of the lung for several days before transplantation.

Although the present invention has been described above with reference to specific embodiment, it is not intended to be limited to the specific form set forth herein. Rather, the invention is limited only by the accompanying claims and other embodiments than the specific above are equally possible within the scope of these appended claims.

In the claims, the term “comprises/comprising” does not exclude the presence of other elements or steps.

Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A system for organ evaluation and preservation for connection to an organ and for recirculation of a perfusion medium, comprising:
a first collection device for collection of the perfusion medium perfused through an organ;
a fluid level sensing device;
a flow regulation device;
a first conduit passing the perfusion medium to the organ, and
a second conduit connected between the first perfusion medium collection device and a second perfusion medium collection device;
wherein the level of the perfusion medium in the second collection device is controlled by the fluid level sensing device and the flow regulation device, which is connected with the fluid level sensing device and is arranged in the second conduit, and wherein said first conduit is connected between said second perfusion medium collection device and said organ.

2. The system according to claim 1, wherein the fluid level sensing device is sensing a fluid level based on at least one of IR, induction, capacitance, UV, and radio waves, and a combination thereof, preferably IR.

3. The system according to claim 1, wherein the flow regulation device is at least one of an on-off clamp, a partial clamp, and a roller pump.

4. The system according to claim 1, further comprising a control unit connected to the fluid level sensing device for controlling the flow regulation device.

5. The system according to claim 1, further comprising a pump, such as a roller pump or a centrifugal pump, arranged in the first conduit between the second perfusion medium collection device and the organ.

6. The system according to claim 1, further comprising an oxygenation device, optionally comprising a heat exchanger.

7. The system according to claim 1, further comprising at least one of an air bubble detector and a defoaming device.

8. The system according to claim 1, wherein the organ to be connected to the system is of human or animal origin and is at least one of a lung, a heart, a liver, a kidney, a pancreas, an intestine, and an extremity, and a part thereof.

9. The system according to claim 8, wherein the perfusion medium to be passed through the organ and to be recirculated in the system is at least one of blood, heparinized natural blood, and Steen solution.

10. The system according to claim 1, further comprising a shunt conduit arranged to bypass the first collection device during a preconditioning step, whereby the perfusion medium is arranged to pass in a closed circuit for adjusting the perfusion medium, for example to at least one of a desired temperature and amount of dissolved gases.

11. A system for organ evaluation and preservation for connection to an organ and for recirculation of a perfusion medium, comprising:
a first collection device for collection of the perfusion medium perfused through an organ;
a fluid level sensing device;
a flow regulation device;
a first conduit passing the perfusion medium to the organ, and
a second conduit connected between the first perfusion medium collection device and a human or animal patient, wherein the level of the perfusion medium in the first perfusion medium collection device is measured by the fluid level sensing device and controlled by the flow regulation device, which is arranged in the conduit, wherein said conduit is arranged between the human or animal patient and the organ.

12. A system for organ evaluation and preservation for connection to an organ and for recirculation of a perfusion medium, comprising:
a first collection device for collection of the perfusion medium, which is passed onto or surrounds an organ;
a fluid level sensing device,
a flow regulation device;
a first conduit passing the perfusion medium onto or surrounding the organ, and
a second conduit connected between the first perfusion medium collection device and a second perfusion medium collection device;
wherein the level of the perfusion medium in the second perfusion medium collection device is controlled by the fluid level sensing device and the flow regulation device, which is connected with the fluid level sensing device and is arranged in the second conduit, and wherein said first conduit is connected to said second perfusion medium collection device passing the perfusion medium onto or surrounding the organ.

13. Method for organ evaluation and preservation, wherein an organ to be transplanted is connected ex-vivo to a system according to of claim 1, and is repeatedly perfused with the perfusion solution and evaluated until it has been determined whether the organ is suitable for transplantation, or until the transplantation is to be performed.

14. Method for organ evaluation and preservation, wherein an organ to be transplanted to a predetermined organ receiving human or animal patient and said human or animal patient both are connected to the system according to claim 1 and is repeatedly perfused with a perfusion medium, such as blood, circulating in the system and is evaluated until it has been decided whether said organ is suitable for transplantation to said predetermined human or animal patient, or until the transplantation is to be performed.
